(19) United States
(12) Patent Application Publication
(10) Pub. No.: US 2006/0184328 A1
(43) Pub. Date: Aug. 17, 2006

(54) Determining and/or monitoring

(75) Inventors: Christopher Henry Orr, Cumbria (GB); John Paul Ronaldson, Cumbria (GB)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(73) Assignee: BIL Solutions Limited

(21) Appl. No.: 11/300,057

(22) Filed: Dec. 14, 2005

(30) Foreign Application Priority Data
Dec. 14, 2004 (GB) 0427262.1
Mar. 9, 2005 (GB) 0504800.4

(51) Int. Cl. G06F 19/00

(52) U.S. Cl. 702/27

(57) ABSTRACT

A method of determining a function and a method of monitoring using a function is provided in which the function relates the proportion of one or more radionuclides detectable using a radiometric instrument to one or more radionuclides which cannot readily be detected using a radiometric instrument to provide more reliable results.

### CROSS-REFERENCE TO RELATED APPLICATIONS

This application claims priority to United Kingdom Patent Application Nos. 0427262.1, filed Dec. 14, 2004 and 0504800.4, filed Mar. 9, 2005, the disclosure of which are incorporated herein by reference.

### BACKGROUND OF THE INVENTION

1. The Field of the Invention

The present invention concerns improvements in and relating to determining and/or monitoring, particularly, but not exclusively in relation to determining a function which relates one or more radionuclides to one or more others and/or for monitoring materials using such functions.

2. The Relevant Technology

In many situations process streams need to be analysed promptly for radionuclides. This is usually achieved through the use of a radiometric instrument which detects one or more characteristics, usually emissions, from the process stream. These easier to detect emissions lead to the harder to detect radionuclides by means of a function which relates the various radionuclides to one another for that process stream. The function remains generally constant for a process stream for a long period of time. Hence occasional radiochemical analysis off line can be performed periodically to provide results, the function can be determined from those results and the monitoring using the radiometric instrument can employ the function to analyse the process stream in an on line manner.

Existing methods have been established by the applicant to include a number of features which impair the accuracy of the function determined and hence impair the monitoring performed using that function.

### SUMMARY OF THE INVENTION

The present invention has amongst its aims, the provision of a method for determining such a function, that is optimised and reliable. The present invention has amongst its aims, the provision of more accurate monitoring of process streams using such a function.

According to a first aspect of the present invention, there is provided a method for determining a function, the function relating the proportion of one or more radionuclides to one or more other radionuclides, the method comprising:
collecting two or more samples from a process stream;
determining the activity for two or more radionuclides in the samples collected from the process stream;
calculating the proportion of the total activity determined which is attributed to each of the radionuclides for which a determination of activity is made, for each of the samples;
combining the proportions to give the function.

The calculating of the proportion of the total activity determined which is attributed to each of the radionuclides for which a determination of activity is made may be provided by normalising the activity of each radionuclide to the total activity. The total activity may be for alpha emitters only. The total activity may be for beta emitters only. The total activity may be for all emitters. Preferably each of the samples is subjected to normalising. Where samples are collected from two or more process streams, preferably each of the samples is subjected to normalisation. Preferably the activity for each of the radionuclides is expressed as a number between 0 and 1 inclusive following the calculating of the proportions.

Preferably the method includes averaging the proportion of the total activity determined which is attributed to each of the radionuclides. The proportions, preferably for each of the radionuclides, preferably for each of the samples, may be added together and divided by the number of samples. Where samples are collected from two or more process streams, preferably each of the process streams are averaged separately. Preferably the averaging follows the calculating of the proportion of the total activity attributed to each of the radionuclides.

Preferably the method is performed on two or more process streams. Preferably a weighting for each of the process streams is provided. Preferably the weighting is provided according to the proportion of the total activity arising from each of the process streams. Preferably, the weighting factors total 100%. The weighting factor of the, or each, component may be expressed in terms other than a percentage. Preferably the activity for a radionuclide from one process stream is combined with the activity for the same radionuclide from the other process streams according to the weightings for the process streams. The combination and weighting may be applied in a single step. Alternatively, the values for the radionuclides in a process stream may be multiplied by the weighting and, potentially, then be summed together. Preferably the result of one or more of the steps of this paragraph is the provision of the function.

The weighting may be calculated from analysis of the total activity, for instance using one or more instruments and/or radiochemical analysis. The weighting may be predicted, for instance from process stream history and/or plant history. The weighting may be provided by a third party, for instance by the plant operator.

The first aspect of the invention may include any of the features, options or possibilities set out elsewhere in this document.

According to second aspect of the present invention, there is provided a method for determining a function, the function relating the proportion of one or more radionuclides to one or more other radionuclides, the method comprising:
collecting a sample from each of two or more process streams;
determining the activity for two or more radionuclides in the samples collected from the process streams;
providing a weighting for each of the process streams, the weighting being provided according to the proportion of the total activity arising from each of the process streams;
combining the activity for a radionuclide from one process stream with the activity for the same radionuclide from the other process streams according to the weightings for the process streams to give the function.

The method may include calculating the proportion of the total activity determined which is attributed to each of the radionuclides for which a determination of activity is made, for each of the samples. Preferably this step is provided before the combining according to the weightings. The calculating of the proportion of the total activity determined which is attributed to each of the radionuclides for which a determination of activity is made may be provided by normalising the activity of each radionuclide to the total activity. The total activity may be for alpha emitters only. The total activity may be for beta emitters only. The total activity may be for all emitters. Preferably each of the samples is subjected to normalising. Where samples are collected from two or more process streams, preferably each of the samples is subjected to normalisation. Preferably the activity for each of the radionuclides is expressed as a number between 0 and 1 inclusive following the calculating of the proportions.

Preferably the method includes averaging the proportion of the total activity determined which is attributed to each of the radionuclides. The proportions, preferably for each of the radionuclides, preferably for each of the samples, may be added together and divided by the number of samples. Where samples are collected from two or more process streams, preferably each of the process streams are averaged separately. Preferably the averaging follows the calculating of the proportion of the total activity attributed to each of the radionuclides.

Preferably, the weighting factors total 100%. The weighting factor of the, or each, component may be expressed in terms other than a percentage. The combination and weighting may be applied in a single step. Alternatively, the values for the radionuclides in a process stream may be multiplied by the weighting and, potentially, then be summed together. Preferably the result of one or more of the steps of this paragraph is the provision of the function.

The weighting may be calculated from analysis of the total activity, for instance using one or more instruments and/or radiochemical analysis. The weighting may be predicted, for instance from process stream history and/or plant history. The weighting may be provided by a third party, for instance by the plant operator.

The second aspect of the invention may include any of the features, options or possibilities set out elsewhere in this document.

According to a third aspect of the present invention there is provided a method for determining a function, the function relating the proportion of one or more radionuclides to one or more other radionuclides, the method comprising:
collecting two or more samples from two or more process streams;
determining the activity for two or more radionuclides in the samples collected from the process stream;
calculating the proportion of the total activity determined which is attributed to each of the radionuclides for which a determination of activity is made, for each of the samples;
providing a weighting for each of the process streams, the weighting being provided according to the proportion of the total activity arising from each of the process streams;
combining the proportion of the activity for a radionuclide from one process stream with the proportion of the activity for the same radionuclide from the other process streams according to the weightings for the process streams to give the function.

The third aspect of the invention may include any of the features, options or possibilities set out elsewhere in this document.

According to a fourth aspect of the present invention we provide apparatus for monitoring a process stream, the apparatus comprising
a detector, the detector providing information on emissions arising from one or more radionuclides in the process stream;
a function stored in the apparatus;
a data processor, the data processor using the information and the function to provide further information on one or more other radionuclides in the process stream;
wherein the function relates the proportion of the one or more radionuclides to the proportion of the one or more other radionuclides and the function is determined by a method including the step of, for each of the samples whose activity is determined, calculating the proportion of the total activity determined which is attributed to each of the radionuclides for which a determination of activity is made.

According to a fifth aspect of the present invention we provide a method for monitoring a process stream, the method comprising
obtaining information on emissions arising from one or more radionuclides in the process stream using a detector;
calculating further information on one or more other radionuclides in the process stream using the information and the function;
wherein the function relates the proportion of the one or more radionuclides to the proportion of the one or more other radionuclides and the function is determined by a method including the step of, for each of the samples whose activity is determined, calculating the proportion of the total activity determined which is attributed to each of the radionuclides for which a determination of activity is made.

The fourth and/or fifth aspects of the invention may include any of the features, options or possibilities set out herein, including the following.

The method for determining a function may comprise: collecting two or more samples from a process stream; determining the activity for two or more radionuclides in the samples collected from the process stream; calculating the proportion of the total activity determined which is attributed to each of the radionuclides for which a determination of activity is made, for each of the samples; and combining the proportions to give the function.

The method for determining the function may comprise: collecting a sample from each of two or more process streams; determining the activity for two or more radionuclides in the samples collected from the process streams; providing a weighting for each of the process streams, the weighting being provided according to the proportion of the total activity arising from each of the process streams; combining the activity for a radionuclide from one process stream with the activity for the same radionuclide from the other process streams according to the weightings for the process streams to give the function.

According to a sixth aspect of the present invention we provide apparatus for monitoring a process stream, the apparatus comprising
a detector, the detector providing information on emissions arising from one or more radionuclides in a process stream formed by the combination of two or more process streams;
a function stored in the apparatus;
a data processor, the data processor using the information and the function to provide further information on one or more other radionuclides in the process stream;
wherein the function relates the proportion of the one or more radionuclides to the proportion of the one or more other radionuclides and the function is determine by a method which includes providing a weighting for each of the process streams, the weighting being provided according to the proportion of the total activity arising from each of the process streams and which further includes combining the proportion of the activity for a radionuclide from one process stream with the proportion of the activity for the same radionuclide from the other process streams according to the weightings for the process streams.

According to a seventh aspect of the present invention we provide a method for monitoring a process stream, the method comprising
obtaining information on emissions arising from one or more radionuclides in a process stream using a detector, the process stream being formed by the combination of two or more other process streams;
calculating further information on one or more other radionuclides in the process stream using the information and the function;
wherein the function relates the proportion of the one or more radionuclides to the proportion of the one or more other radionuclides and the function is determined by a method which includes providing a weighting for each of the other process streams, the weighting being provided according to the proportion of the total activity arising from each of the other process streams and which further includes combining the proportion of the activity for a radionuclide from one of the other process streams with the proportion of the activity for the same radionuclide from the other of the other process streams according to the weightings for the other process streams.

The sixth and/or seventh aspects of the invention may include any of the features, options or possibilities set out herein, including the following.

The method for determining the function may comprise: collecting a sample from each of two or more process streams; determining the activity for two or more radionuclides in the samples collected from the process streams; providing a weighting for each of the process streams, the weighting being provided according to the proportion of the total activity arising from each of the process streams; combining the activity for a radionuclide from one process stream with the activity for the same radionuclide from the other process streams according to the weightings for the process streams to give the function.

Preferably the method for determining the function includes the step of, for each of the samples whose activity is determined, calculating the proportion of the total activity determined which is attributed to each of the radionuclides for which a determination of activity is made. The method for determining a function may comprise: collecting two or more samples from a process stream; determining the activity for two or more radionuclides in the samples collected from the process stream; calculating the proportion of the total activity determined which is attributed to each of the radionuclides for which a determination of activity is made, for each of the samples; and combining the proportions to give the function.

Any of the above mentioned aspects of the present invention may include any of the features, options or possibilities set out elsewhere in this application, and in particular from amongst the following.

The function preferably relates one or more radionuclides detectable using a radiometric instrument to one or more radionuclides which cannot, at least readily, be detected using a radiometric instrument. Preferably the function relates all of the radionuclides in the process stream to one or more radionuclides which can be detected by a radiometric instrument. The radionuclides may be directly related by the function and/or more be indirectly related. The function may be a radionuclide fingerprint and/or scaling factor and/or radionuclide vector.

In particular for alpha radionuclides, the function may relate the proportion of one or more of the following list to one or more different isotopes in the following list: Pu²³⁸, Pu²³⁹, Pu²⁴⁰, Am²⁴¹, U²³⁴, U²³⁵. In particular for beta radionuclides, the function may relate the proportion of one or more of the following list to one or more different isotopes in the following list: Co⁶⁰, Sr⁹⁰, Ru¹⁰⁶, Cs¹³⁴, Cs¹³⁷, Eu¹⁵². In particular for total radionuclides, the function may relate the proportion of one or more of the following list to one or more different isotopes in the following list: Pu²³⁸, Pu²³⁹, Pu²⁴⁰, Am²⁴¹, U²³⁴, U²³⁵, Co⁶⁰, Sr⁹⁰, Ru¹⁰⁶, Cs¹³⁴, Cs¹³⁷, Eu¹⁵².

The collecting of the sample(s) may involve swabbing and/or direct collection. Preferably two or more samples are taken for all process streams considered by the method. Preferably the same number of samples are taken for each of the process streams.

The method may be used to obtain a function for a process stream which is a result of the combination of two or more other process streams. Preferably one or more samples are taken from each of the other process streams. The other process streams may represent different types of material and/or different material sources and/or material from different areas or locations of a plant and/or material from different plant and/or material containing different radionuclides and/or proportions thereof.

The determination of the activity may involve the determination of the alpha emitting radionuclides present. One or more, preferably two or more, of the following alpha emitting radionuclides may be determined: Pu²³⁸, Pu²³⁹, Pu²⁴⁰, Am²⁴¹, U²³⁴, U²³⁵. The determination of the activity may involve the determination of the beta emitting radionuclides present. One or more, preferably two or more, of the following beta emitting radionuclides may be determined: Co⁶⁰, Sr⁹⁰, Ru¹⁰⁶, Cs¹³⁴, Cs¹³⁷, Eu¹⁵². The determination of the activity may involve the determination of all emitting radionuclides present. The activity may be expressed in terms of activity per unit sample and/or activity per gram of sample. Preferably the same units are used for each activity. The activity for one or more isotopes may be stated separately. The activity for two or more isotopes may be stated together. The determination of the activity may be made by radiochemical analysis.

### BRIEF DESCRIPTION OF THE DRAWINGS

Various embodiments of the invention will now be described, by way of example only, and with reference to the accompanying drawings in which:-

FIG. 1 is an illustration of the working of the invention on samples considered for alpha activity;

FIG. 2 is an illustration of the working of the invention on samples considered for a beta activity; and

FIG. 3 is an illustration of the working of the invention on samples considered for a total activity.

### DETAILED DESCRIPTION OF THE PREFERRED EMBODIMENTS

In a variety of situations process streams need to be analysed and the radionuclides identified and quantified. Such situations occur in industries concerned with the nuclear fuel cycle, industries concerned with the decommissioning of nuclear facilities and a variety of other industries. In particular, process streams may be analysed to ensure the correct operation of a process and process streams may be analysed to quantify the radionuclides therein for disposal purposes. Decommissioning of plant in particular generates a significant volume of waste which must be accurately analysed to ensure safe and yet cost efficient disposal strategies.

Analysis of process streams is usually performed by an online instrument which detects one or more characteristics of the process stream. The one or more characteristics detected usually only relate to one or a few of the radionuclides present. The radionuclides directly detected are normally those which present a convenient energy and strength of emission for detection.

From the directly detectable radionuclide(s), it is possible to calculate information on the other radionuclides using a function. The function is commonly referred to as a “fingerprint” in the UK and US, “nuclide vector” in Germany and “scaling factors” in Japan. The function relates the proportions of the directly detected radionuclides to the non-directly detected radionuclides. The function for a process stream is obtained through a variety of offline radiochemical analyses on physical samples of the process stream which are collected and then analysed in a laboratory. Once obtained, the function can be used in the calculations for that process stream for a considerable period of time as the function is fairly constant over time. Hence the quickly available results from radiometric detection of certain nuclides can be extended as quickly to cover all the radionuclides.

Developments are being made with a view to improving and standardising the radiochemical analysis methods used in the analysis of the physical samples.

Significant issues also exist with respect to the way in which the function is derived from the radiochemical analysis and/or used subsequently. These issues remain, even if the accuracy of the radiochemical analysis itself is improved.

In the existing method for deriving the function, greater weight is given to the radiochemical results from high activity samples compared with low activity samples. Far more weight is thus given to one sample with an activity of 1000, therefore, than the fact that the other three sample all gave an activity of 100. The applicant has established that this weighting is undesirable to the accuracy of the function and consequently also reduces the accuracy of further steps which use the function.

A further issue with the existing method is that the function may need to represent the combined function of a number of different process streams. Such a situation exists where waste is being analysed for storage and long term disposal, the actual process stream, with that waste coming from the dismantling of a building (a first process sub-stream), from equipment within the building (a second process sub-stream) and the soil around the building (a third process sub-stream). The existing approach merely assumes the function for the process stream to be the average of the three process sub-streams. The applicant has established that this is potentially inaccurate and that it may not even be appropriate to generate a single function for such a process stream formed from a number of process sub-streams.

The preferred method according to the invention is as follows, demonstrated in the context of a function for a process stream formed from three process sub-streams, each of which arises from a different area in the part of the plant being decommissioned.

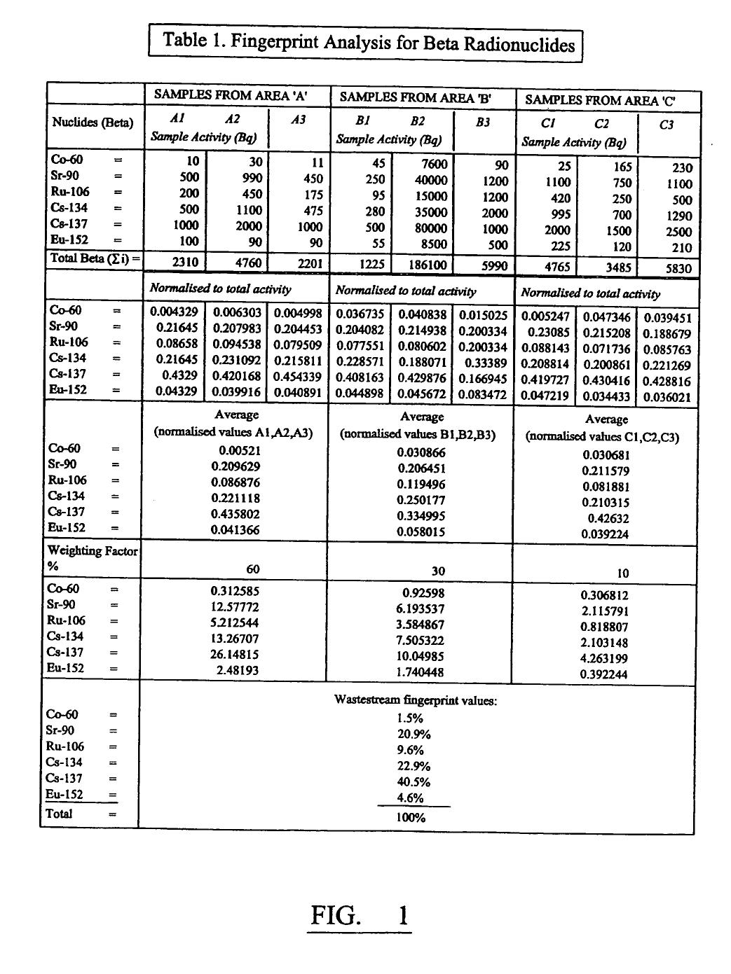

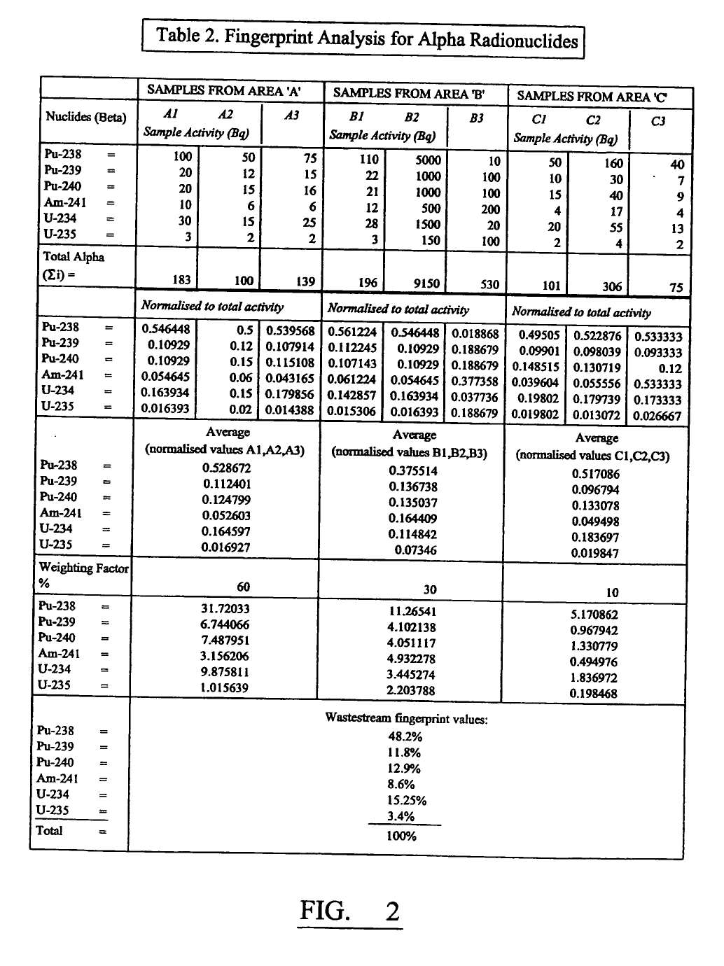

FIG. 1 details the operation of the method in the context of the beta emitting nuclides. For each of the three areas, A, B, C, three samples are collected and analysed using radiochemical techniques. These thus form samples A1 to A3, B1 to B3 and C1 to C3. The laboratory results provide sample activity values for each nuclide in each sample. These are listed in the “Sample Activity” columns and in this case are expressed in units of Bq.

The individual isotope values in each sample are totalled to give the total beta activity shown in the row marked (Σi).

As can clearly be seen the activity for sample B2 is massively higher than the others. In the prior art method the ratios between isotopes from this sample would dominate the function, on the basis that the higher activity means this sample is more statistically significant.

In a significant change over the prior art, the activity of each named radionuclide is then normalised to total beta activity in the next part of the calculation. This data is given in the columns below the title “Normalised to total activity”. Doing this removes the potential bias that can occur from the likes of the B2 sample. Hence the accuracy of the method is not upset where one sample happened to be collected from a high activity “hot-spot” by chance and/or was in error for some other reason. Specifically within the worked example, whilst sample B2 has an activity approx 50× greater than other samples, the normalised activity values for B2 are consistent with the other samples.

Following on from this step, the normalised radionuclide results for samples from the same area are then averaged. This is performed by the summation of normalised activity values for each radionuclide, followed by their division by the number of samples. The resulting data is given under the headings “Average (normalised values #1, #2, #3)”.

In another deviation from the prior art method, the results for the three areas are not just simply combined. Instead information on the proportion of the process stream coming from each of the three areas is obtained. The plant manager and/or decommissioning coordinator and/or plant records and/or a dose rate survey of samples from the areas and/or other sources can be used to obtain this information. It is important to note that it is the total activity of the process sub-stream from each area whose proportion is being considered, not the total volume of those sub-streams. For the worked example it is established that area “A” generates 60% of the activity, area “B” generates 30% of the activity, and area “C” generates 10% of the activity. These proportions are then taken as weighting factors for the combined function. The values mentioned are set out in the row marked “Weighting Factor (%)”. The weighting of results to reflect this split of activity is reflected by multiplying all radionuclide values in the “Average” columns calculated above by the weighting factor value for that area. In the example, the “Average” values would be multiplied by 60(%) for area “A” values, 30(%) for area “B” values and 10(%) for area “C” values.

Finally, the weighted radionuclide values calculated above for each area are summed. This will result in the final function with each radionuclide expressed as a percentage of the total beta activity. The final function values are listed in the column below “Wastestream fingerprint values:”. Values have been rounded to 1 decimal place. It is important to note that the “odd-ball” result of sample B2 has not significantly affected the final fingerprint as a result of this analysis method and that the function is suitably weighted to reflect the relative contributions of the different areas to the total activity.

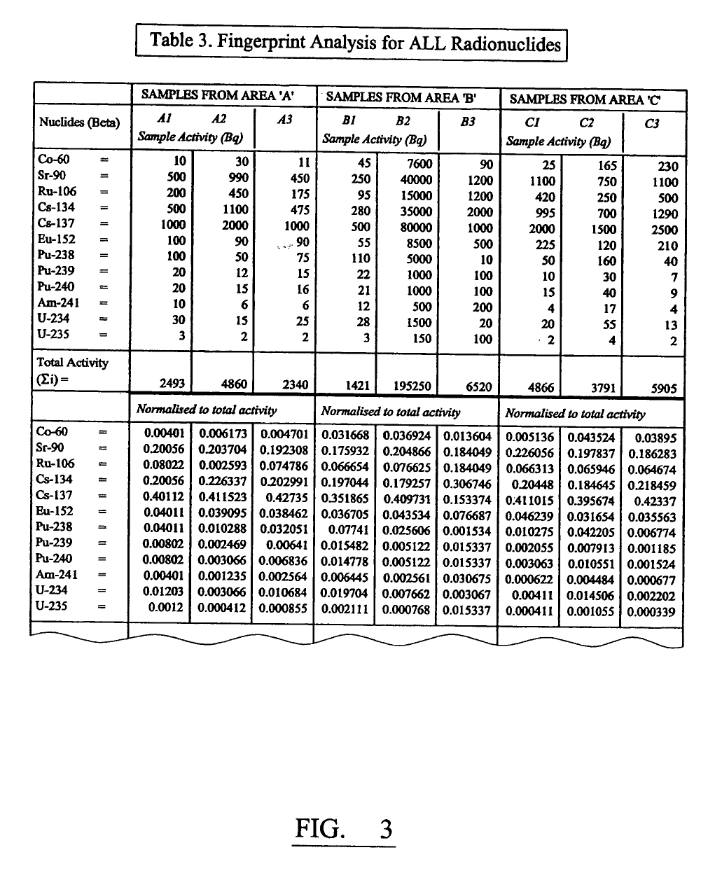

If a function is required for the alpha radionuclides then this is calculated in the same way, but with the radiochemical analysis concerning itself with the alpha emitters. An example is provided in FIG. 2.

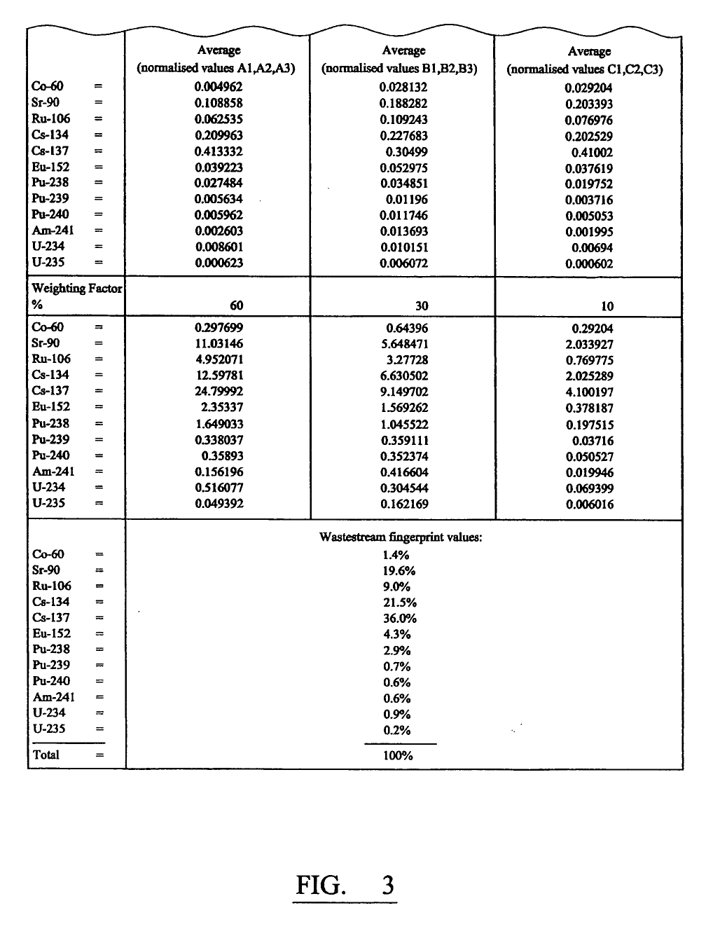

If a function is required reflecting both the alpha and beta radionuclides then this can be obtained by including both sets of radionuclides in the initial “Sample Activity” list. The procedure described above will then provide a function that indicates the activity percentage of each radionuclide referenced to total (ie alpha plus beta) activity. An example is provided in FIG. 3.

The above described method is applicable to the radiochemical analysis results obtained in a variety of ways, for instance through the use of swabs or samples taken. Furthermore, the method is applicable to a number of different ways in which the chemistry laboratories may present their results, for instance named isotopes quantified in terms of “Bq per sample” or “Bq per gram” of sample. The results used should be consistently expressed for all sample results. The method is also fully applicable where some of the radionuclides are expressed in alternative ways, for instance, laboratories sometimes return results featuring “unusual” radionuclides under titles such as “Other uranium”.

Through the use of the new method, it is possible to reach a determination that a function which represents the combination of a number of process sub-streams is not an appropriate way to handle the position. In such a case, the appropriate course of action could be to combine the results for a first process sub-stream and a second process sub-stream together in the manner described above, but to calculate and apply an entirely separate function in respect of the third process sub-stream.

A further advantage with the invention is that the accurate consideration of the radiochemical analysis could confirm as being accurate a strategy where a process sub-stream from one part of the decommissioning operation is combined and considered through a single function, with a process sub-stream from an entirely different part of the decommissioning operation. Greater flexibility and options for dealing with the process streams are thus provided.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for monitoring a process stream, the method comprising:
obtaining information on emissions arising from one or more radionuclides in the process stream using a detector;
calculating further information on one or more other radionuclides in the process stream using the information and a function;
wherein the function relates the proportion of the one or more radionuclides to the proportion of the one or more other radionuclides and the function is determined by a method including the steps of:
collecting two or more samples from a process stream;
determining the activity for two or more radionuclides in the samples collected from the process stream;
calculating the proportion of the total activity determined which is attributed to each of the radionuclides for which a determination of activity is made, for each of the samples; and
combining the proportions to give the function.

2. A method for monitoring according to claim 1 in which the function is determined by a method which further comprises:
collecting a sample from each of two or more process streams;
determining the activity for two or more radionuclides in the samples collected from the process streams;
providing a weighting for each of the process streams, the weighting being provided according to the proportion of the total activity arising from each of the process streams;
combining the activity for a radionuclide from one process stream with the activity for the same radionuclide from the other process streams according to he weightings for the process streams to give the function.

3. A method for monitoring according to claim 1 in which the function relates one or more radionuclides detectable using a radiometric instrument to one or more radionuclides which cannot readily be detected using a radiometric instrument.

4. A method for monitoring according to claim 1 in which the function relates the proportion of one or more of Pu²³⁸, Pu²³⁹, Pu²⁴⁰, Am²⁴¹, U²³⁴, U²³⁵ to one or more different isotopes from Pu²³⁸, Pu²³⁹, Pu²⁴⁰, Am²⁴¹, U²³⁴, U²³⁵.

5. A method for monitoring according to claim 1 in which the function relates the proportion of one or more of Co⁶⁰, Sr⁹⁰, Ru¹⁰⁶, Cs¹³⁴, Cs¹³⁷, Eu¹⁵² to one or more different isotopes from Co⁶⁰, Sr⁹⁰, Ru¹⁰⁶, Cs¹³⁴, Cs¹³⁷, Eu¹⁵².

6. A method for monitoring according to claim 1 in which the calculating of the proportion of the total activity determined which is attributed to each of the radionuclides for which a determination of activity is made by normalising the activity of each radionuclide to the total activity.

7. A method for monitoring according to claim 6 in which each of the samples is subjected to normalising.

8. A method for monitoring according to claim 2 in which each of the samples is subjected to normalisation.

9. A method for monitoring according to claim 1 in which the function is determined by a method which includes averaging the proportion of the total activity determined which is attributed to each of the radionuclides.

10. A method for monitoring according to claim 2 in which the function is determined by a method which includes averaging the proportion of the total activity determined which is attributed to each of the radionuclides, each of the process streams being averaged separately.

11. A method for monitoring a process stream, the method comprising:
obtaining information on emissions arising from one or more radionuclides in a process stream using a detector, the process stream being formed by the combination of two or more other process streams;
calculating further information on one or more other radionuclides in the process stream using the information and the function;
wherein the function relates the proportion of the one or more radionuclides to the proportion of the one or more other radionuclides and the function is determined by a method which includes:
collecting a sample from each of two or more process streams;
determining the activity for two or more radionuclides in the samples collected from the process streams;
providing a weighting for each of the process streams, the weighting being provided according to the proportion of the total activity arising from each of the process streams;
combining the activity for a radionuclide from one process stream with the activity for the same radionuclide from the other process streams according to the weightings for the process streams to give the function.

12. A method according to claim 11 in which the function relates one or more radionuclides detectable using a radiometric instrument to one or more radionuclides which cannot readily be detected using a radiometric instrument.

13. A method according to claim 11 in which the function relates the proportion of one or more of Pu²³⁸, Pu²³⁹, Pu²⁴⁰, Am²⁴¹, U²³⁴, U²³⁵ to one or more different isotopes from Pu²³⁸, Pu²³⁹, Pu²⁴⁰, Am²⁴¹, U²³⁴, U²³⁵.

14. A method according to claim 11 in which the function relates the proportion of one or more of Co⁶⁰, Sr⁹⁰, Ru¹⁰⁶, Cs¹³⁴, Cs¹³⁷, Eu¹⁵² to one or more different isotopes from Co⁶⁰, Sr⁹⁰, Ru¹⁰⁶, Cs¹³⁷, Eu¹⁵².

15. A method for monitoring according to claim 11 in which the weighting is calculated from analysis of the total activity.

16. A method for monitoring according to claim 11 in which the weighting is predicted.

17. A method for monitoring according to claim 16 in which the weighting is predicted from process stream history or plant history.

18. A method for determining a function relating the proportion of one or more radionuclides to one or more other radionuclides, the method comprising:
collecting two or more samples from a process stream;
determining the activity for two or more radionuclides in the samples collected from the process stream;
calculating the proportion of the total activity determined which is attributed to each of the radionuclides for which a determination of activity is made, for each of the samples;
combining the proportions to give the function.

19. A method for determining a function, the function relating the proportion of one or more radionuclides to one or more other radionuclides, the method comprising:
collecting a sample from each of two or more process streams;
determining the activity for two or more radionuclides in the samples collected from the process streams;
providing a weighting for each of the process streams, the weighting being provided according to the proportion of the total activity arising from each of the process streams;
combining the activity for a radionuclide from one process stream with the activity for the same radionuclide from the other process streams according to the weightings for the process streams to give the function.
